(19) United States
(12) Patent Application Publication
(10) Pub. No.: US 2003/0046593 A1
(43) Pub. Date: Mar. 6, 2003

(54) Data storage device security method and apparatus

(76) Inventors: Wen Xiang Xie, Singapore (SG); Wei Loon Ng, Singapore (SG)

Correspondence Address: Kirk A. Cesari, Seagate Technology LLC, 1280 Disc Drive, Shakopee, MN, 55379, US

(21) Appl. No.: 10/146,079

(22) Filed: May 14, 2002

Related U.S. Application Data
(60) Provisional application No. 60/315,428, filed on Aug. 28, 2001.

(51) Int. Cl. H04L 9/32

(52) U.S. Cl. 713/202

(57) ABSTRACT

Methods for improving security in data storage devices are disclosed. The methods include a synchronization method by which an encrypted password, using any known encryption algorithm, keeps changing at each transmission from host to data storage device. Additionally, a security system for implementing the security method is provided.

### RELATED APPLICATION

This application claims the benefit of U.S. Provisional Application Serial No. 60/315,428 entitled “METHOD OF LOCKING A DISC DRIVE TO ITS DESIGNATED HOST AND SYNCHRONIZING CHANGING PASSWORDS BETWEEN THEM”, filed Aug. 28, 2001 under 35 U.S.C. 119(e).

### FIELD OF THE INVENTION

This application relates generally to the field of data storage and retrieval. More particularly, this invention relates to the security system between a host and a data storage device. The present invention relates to a method and apparatus for linking a data storage device to a designated host to prevent copying of data stored on the data storage device.

### BACKGROUND OF THE INVENTION

Currently, consumers can order music or video for listening or viewing within a household. One common type of ordering is pay per view where a consumer pays a fee to watch a movie at a particular time. In another ordering system, the consumer orders music or a movie from a call-in-center or directly from a set top box. The movie or music is distributed to the set top box within the consumer's home.

The set top box includes a data storage device, such as a disc drive, flash memory, or some other data storage device, on which the music file or movie file is stored. The movie or song can then be viewed or listened to at a later time convenient to the consumer. Since songs and movies have value, security measures are placed in the set top box so that the files containing the songs or movies cannot be copied from the data storage device. Even though security measures are in place, numerous methods have been developed to overcome the current security measures. The result is wide distribution of bootlegged copies of movies and songs that result in lost revenues for the owners and distributors of the bootlegged works.

In order to prevent unauthorized copying of works that would normally have to be paid for, a host and a data storage device are generally provided with some sort of security system. One of the simplest security systems controls access to the data storage device with the use of a password. However, a security system with a plaintext password does not offer adequate protection since it is vulnerable to attack.

A better security system involves encrypting the password before transmission to protect it from unintended disclosure or modification. Encrypting a password involves applying a mathematical algorithm to plaintext information to transform the plaintext information into ciphertext. Applying the mathematical algorithm includes a computational process (i.e. an algorithm) using a key to convert plaintext into ciphertext. Only the holder of the corresponding decryption key can decrypt the resulting encrypted text. To date, a large number of encryption algorithms have been explored in the literature. For example, International Data Encryption Algorithm (IDEA), by Xuejia Lai and James Massey, with a block size of 64 bits and a key length of 128 bits can be used for encryption/decryption purpose. For the details of IDEA, please refer to the book “Applied cryptography: protocols, algorithm and source code in C”, by Bruce Schneier.

Password security systems have several shortcomings. One of the more significant shortcomings of password security systems is that the password to be transmitted is usually fixed. This is a shortcoming even when the password is encrypted. Such a shortcoming can lead to unauthorized access.

Some security systems provide for different codes to be sent. For example, the KEELOQ code hopping technology by Microchip Company can make each transmission by an encoder unique. The content to be transmitted by an encoder using this technology has two parts. The first part of the content is referred to as the hopping code part and the second part is the unencrypted part of the transmission. The hopping code part is a 32-bit part. The hopping code part consists of 4-bit function information, a 12-bit discrimination value and a 16-bit synchronization counter and is encrypted by an encryption algorithm before transmission. The information in this part is different each time the encoder is activated since one bit in the data is changed. The second part is the unencrypted part of the transmission containing the encoder's serial number, which is used to identify the encoder to a decoder. For more details, please visit the web page of Microchip Company “http://www.microchip.com/10/lit/pline/security/index.htm”.

The KEELOQ technology has several disadvantages including:

1. The KEELOQ technology provides high level security mainly based on keeping the algorithm a secret.

2. All security information including discrimination value and synchronization counter, except the key, is transmitted between encoder and decoder at each transmission.

Thus, it is vulnerable to persons who know the encryption algorithm, such as the engineers responsible for encoder design, or people that learn the code to service various components of a system. The disadvantages limit the use of the KEELOQ technology mostly to remote control systems. As can be seen by the above shortcomings, there is a need for new security systems that enhance the security in data storage devices. There is a further need to enhance security of data storage devices used in the consumer electronics environment.

### Current Implementation

Current data storage devices include security features. For example, ATA hard disc drives are commonly used with computers as data storage devices. To prevent any unauthorized users from accessing the data stored on such devices, it is necessary to implement certain security features in the devices. The existing security feature set implemented in ATA hard disc drives provides a method for limiting data access to only authorized users or host systems.

As implemented, the security features are actually a password security that allows for a completely contained system to limit access to information and data on the drive. The ATA hard disc drive stores the access password on its own media even though the password is set through a host computer. The drive uses the same password wherever it is unplugged and then attached. As a result, if the security system is enabled in the drive and it later is stolen or lost, the data stored on it cannot be accessed without the correct access password.

The security system has two kinds of passwords, User and Master, and two security levels, High and Maximum. The difference between the High security level and the Maximum security level lies in device behavior when the User password is lost. If a user forgets the User password when the High level security is set in the drive, the user cannot access any data stored on the hard disc drive. The Master password can be used to unlock the drive in this case. If the user forgets the User password when the Maximum level security is set in the drive, the user cannot access data on the disc drive and all user data will be lost. The Master password, together with SECURITY ERASE PREPARE and SECURITY ERASE UNIT commands, can be used to unlock the disc drive so that the disc drive can be used, but all user data stored in the drive is erased at the same time.

In general, a User password is up to 32 bytes long according to the ATA standard, and is handled through an operating system, or application software, to link the disc drive security system via the ATA interface. During the normal operation of a drive, the Master password is not used unless the User password is lost.

Under the ATA security feature set, a disc drive operates in one of three modes: locked, unlocked and frozen. In locked mode, the disc drive rejects any access or change for the data stored on it. In other words, when in locked mode, the drive automatically aborts all read and write commands without executing them. In the unlocked mode, the disc drive receives commands and fulfills all commands including command for changing password sent to it. The unlocked mode occurs in the disc drive before a User password is set in the system. The User password is set with command SECURITY SET PASSWORD, while a valid User or Master password is used to subsequently unlock the locked drive with the command SECURITY UNLOCK. The frozen mode prevents unauthorized persons from changing the password of an unattended disc drive. In the frozen mode, the disc drive carries out all normal read and write operations but will not change its security level or password in frozen mode. The frozen mode is set with a command SECURITY FREEZE LOCK. A hard disc drive that implements the ATA security feature set implements the following commands:

1. SECURITY SET PASSWORD

2. SECURITY UNLOCK

3. SECURITY ERASE PREPARE

4. SECURITY ERASE UNIT

5. SECURITY FREEZE LOCK

6. SECURITY DISABLE PASSWORD

In summary, a typical application of the securing features of an ATA disc drive works as follows:

1. The user sets a password

2. The next time the disc drive powers up, the drive is in locked mode until the user sends the Unlock command with the valid password.

3. The drive remains in the Unlocked mode until the disc drive is powered down.

4. The user may choose to send a Freeze Lock command to prevent other users from changing password while the disc drive is in the Unlocked mode.

5. Without the valid password on the drive's powering up, the drive remains locked. Depending on the level of security set, the disc drive can be accessed after a Master password is used or may be totally erased after the Master password is used.

Security features similar to those associated with the ATA disc drive have many problems. The problems include the obvious drawback that the password is sent openly over the bus. As a result, the password can be captured using an bus analyzer. Once the password is known, the data storage device can be unlocked and moved to another system. Still a further problem is that without knowing the actual password, the data storage device can be hot-plugged to any other computer once the data storage device is unlocked. Once hot-plugged and moved to another computer, all of the data stored on the data storage device can be copied.

Protecting the data content of a storage device from unauthorized access and locking a storage device to a designated host are two major features requested by the consumer electronics industry to stop data (video, music, etc.) piracy. Current standards such as the ATA security standard clearly lack this ability. Thus, there is a need for new security systems that enhance the security in data storage devices. There is a further need to enhance security of data storage devices used in the consumer electronics environment.

### SUMMARY OF THE INVENTION

The present invention relates to data processing systems that have a host and a data storage device which solve the above-mentioned problems. A method for improving security in data storage devices is disclosed. The method is a technique by which an encrypted password, using any known encryption algorithm, changes after a designated event. The determination of when the encrypted password changes being independent of whether or not the original password has changed.

The present invention can also be implemented as a computer-readable program storage device which tangibly embodies a program of instructions executable by a computer system to perform a security method. In addition, the invention also can be implemented as a security system itself.

These and various other features as well as advantages which characterize the present invention will be apparent upon reading of the following detailed description and review of the associated drawings.

### BRIEF DESCRIPTION OF THE DRAWINGS

FIG. 1 is an exploded view of a disc drive.

FIG. 2 is a schematic view of a host computer and a data storage device according to one embodiment of the present invention.

FIG. 3 is a flow chart showing an initialization procedure for the security system according to one embodiment of the present invention.

FIG. 4 is a flow chart showing a procedure associated with the host computer according to one embodiment of the present invention.

FIG. 5 is a flow chart detailing a preferred embodiment security method.

### DETAILED DESCRIPTION

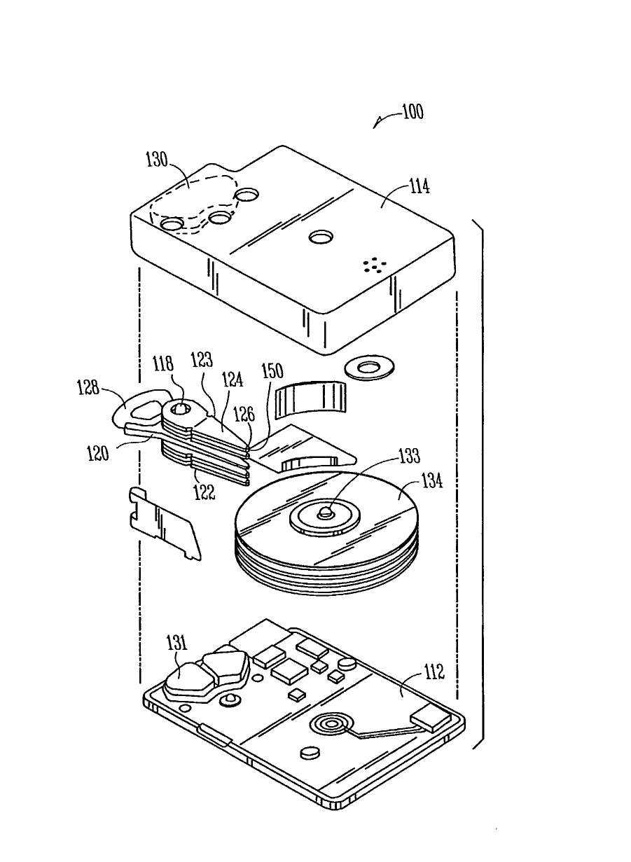

FIG. 1 is a view of one type of data storage device, namely a disc drive, that is capable of using an apparatus and method to link a data storage device to a designated host to prevent copying of data stored on the device. Specifically, FIG. 1 is an exploded view of a disc drive 100. The disc drive 100 includes a housing or base 112, and a cover 114. The base 112 and cover 114 form a disc enclosure. Rotatably attached to the base 112 on an actuator shaft 118 is an actuator assembly 120. The actuator assembly 120 is used to place a transducer 150 in transducing relation with respect to the disc 134 so that magnetic transitions representing data can be written to a track on the disc 134 or so that the magnetic transducer can read data from the disc 134.

The invention described in this application is useful with all configurations of disc drives. The data storage device can be a hard disc drive or any other type of storage device that stores data and retrieves data from a host computer 2000.

The basic requirements for a data storage device and a corresponding host is that they both must be able to execute an encryption/decryption algorithm, store a password, and store and update the value of separate counters used for synchronization. The values of the counters can be synchronized and may be used as the key for the encryption/decryption algorithms and may be used as the basis for the encrypted password changing at each transmission. As a result, the values of the synchronization counters and the programs needed to execute the encryption/decryption algorithms must be stored in a secure area. For example, in hard disc drives, both the password and the value of the synchronization counter can be stored in a reserved area not accessible to end users.

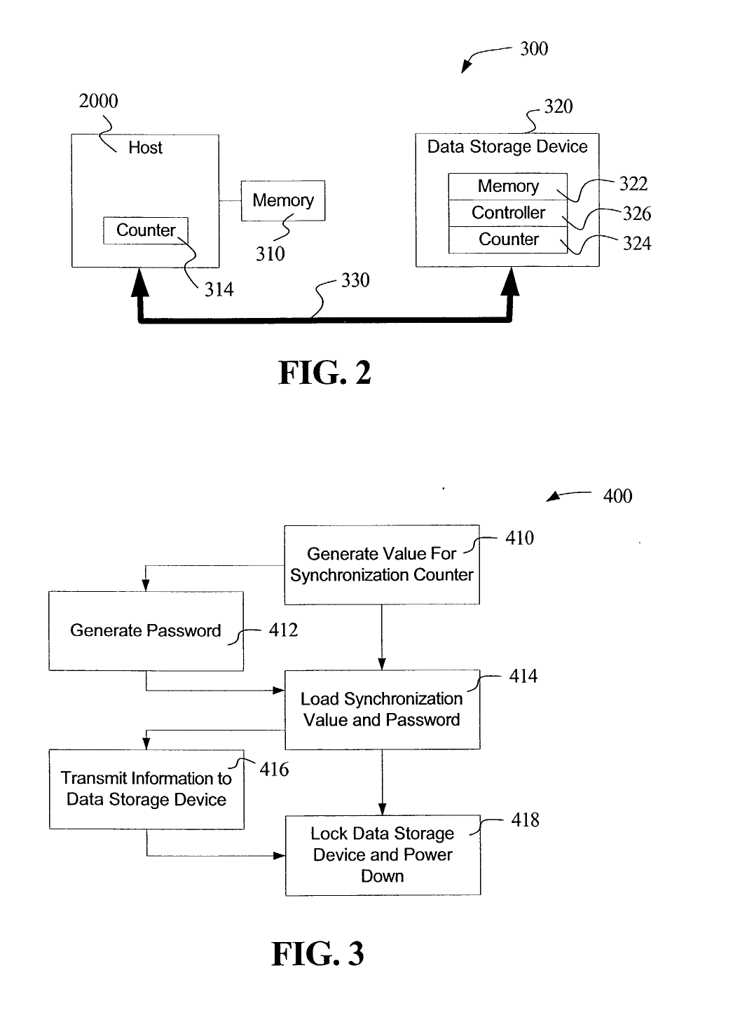

FIG. 2 shows a block diagram of a consumer electronics (“CE”) product 300. FIG. 2 includes a host computer 2000 and at least one data storage device 320, according to the present invention. The computer 2000 includes a synchronization counter 314, and memory 310. The memory 310 may include the BIOS boot code, the password, and the encryption/decryption algorithm. The memory 310 is not generally accessible by a user, and therefore the password and the algorithm for encryption/decryption can be securely stored within the computer 2000. The data storage device 320, which may be a disc drive, usually includes a controller 326, a synch counter 324, and memory 322. The memory 322 is generally inaccessible to the user. If the data storage device 320 is a disc drive, the memory 322 may be similar to that located on a reserved area of the disc drive. A reserved area of a disc drive is usually inaccessible to the user, and may include information necessary to control and run the disc drive or data storage device 320. The computer system 2000 and the data storage device 320 are linked together via a bus 330. On the reserve area of a disc or in the memory 322, a password and the synchronization counter value can be stored. In operation, the password stored in memory 310 is combined with a value from the synch counter 314. The value from the synch counter is used to generate a key value for the encryption/decryption algorithm. Using the encryption key and the password, an encrypted password is produced, which is sent to the data storage device 320. At the data storage device 320, the password may be stored on the reserve area of the disk. The synchronization counter is used to generate a decryption key for decrypting the encrypted password to obtain the decrypted password. The synch counters 314 and 324 may be set at manufacture, as well as the passwords within memory 310 and 322. To have access to the data on storage device 320, the decrypted password must match with the stored password. There may be multiple requirements which demand the host computer 2000 or data storage device 320 to verify the password. Some of these requirements may include: a power up sequence, a specified time period, random timing intervals, the data storage device being disconnected from the host computer 2000, or a command from the host 2000 or data storage device 320.

With this general overview, a detailed description of one embodiment of a method and apparatus will now be discussed. The following example will use

Step 1: Initialization

At the time of manufacture, a consumer electronics (“CE”) product is initialized. FIG. 3 is a flow diagram showing an initialization method 400. Initialization is done before the CE product is shipped to an end-user. An initial value, preferably 128 bits, is generated for synchronization counter 314 at the host computer 2000, as depicted by step 410. A unique password is also generated at the host, as depicted by reference number 412. The password and the initial value for synchronization counter 314 may be generated randomly or by any other method. The synchronization counter value and unique password are loaded into the host computer 2000, as depicted by step 414. Then, the host computer 2000 sends the initial value from counter 314 to the designated data storage device 320 along with the unique password and an unlock time limit, as depicted by step 416. After initialization, the data storage device is placed in locked mode whenever a locked mode has been initiated. Usually a locked mode is initiated when a time limit expires for receiving a password, or after the data storage device is powered down, as depicted by step 418.

The unlock time limit protects the data storage device, such as a drive 100 against a hot-plug attack. A hot plug attack entails disconnecting a data storage device 320 operating in unlocked mode from the associated host computer 2000 and reconnecting the data storage device to another host computer. Another method of hot-plugging entails removing a data storage device from the host during a download from the host computer. The unlock time limit is set so that the time before going into locked mode is short enough so that if a hot-plug attack is attempted, there is insufficient time for downloading a significant amount of the data stored on the data storage device 320. In other words, the data storage device 320, such as a disc drive 100, always goes into locked mode after a specified time. Thus, if an unlocked disc drive is hot-plugged into another system, the unlocked disc drive will be locked in a short time, thereby preventing the copying of information, such as files containing movies, songs, or other data.

When the CE product 300 and its associated data storage device 320 are powered up, the attached data storage device 320, such as disc drive 100, is unlocked before the device 320 comes into use. The password and the value of the synchronization counter remain inaccessible to the end-user and are stored inside the CE product 300 on a non-readable area associated with a reserved area of the data storage device 320. The reason why the initial value of synchronization counter is handled in such a way is to guarantee that nobody knows the value. Thus, the security system of the CE product 300 shall not be compromised even though its password is disclosed.

Step 2: Unlock a Matched Device

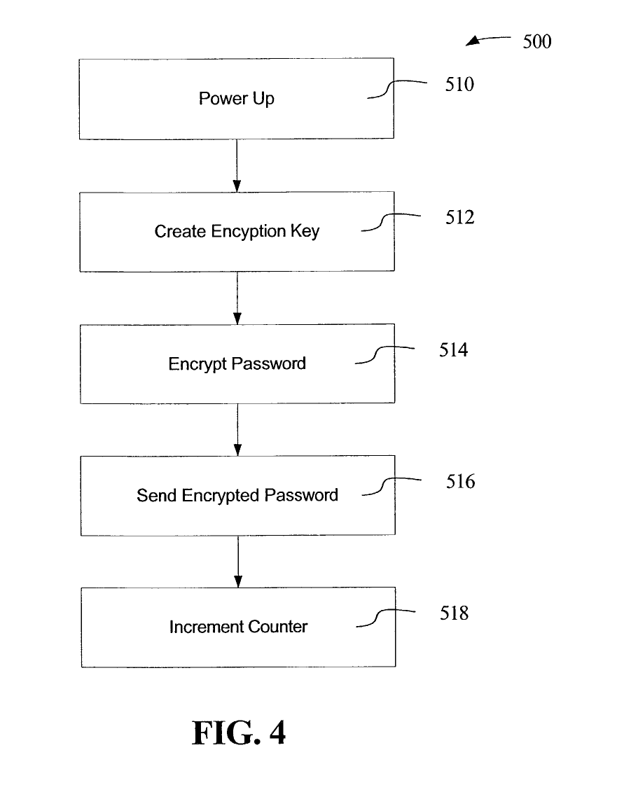

FIG. 4 is a flowchart of the unlocking procedure 500 at power up of the CE product 300. The CE product 300, and more specifically the host computer 2000 and data storage device 320, are powered up, as depicted by step 510. After power up, the host computer 2000 associated with the CE product 300 sends an encrypted password to unlock the locked data storage device 320 before it enters into normal operations. To accomplish this, the host computer 2000 of CE product 300 generates an encryption key based on the synchronization counter 314, as depicted by reference numeral 512. Then, the host computer 2000 encrypts the password for unlocking the data storage device, as depicted by reference number 514. The host computer 2000 then sends out the encrypted password to the data storage device 320 over the bus 330, as depicted by reference number 516. The host computer 2000 then increments the synchronization counter 314, as depicted by reference number 518.

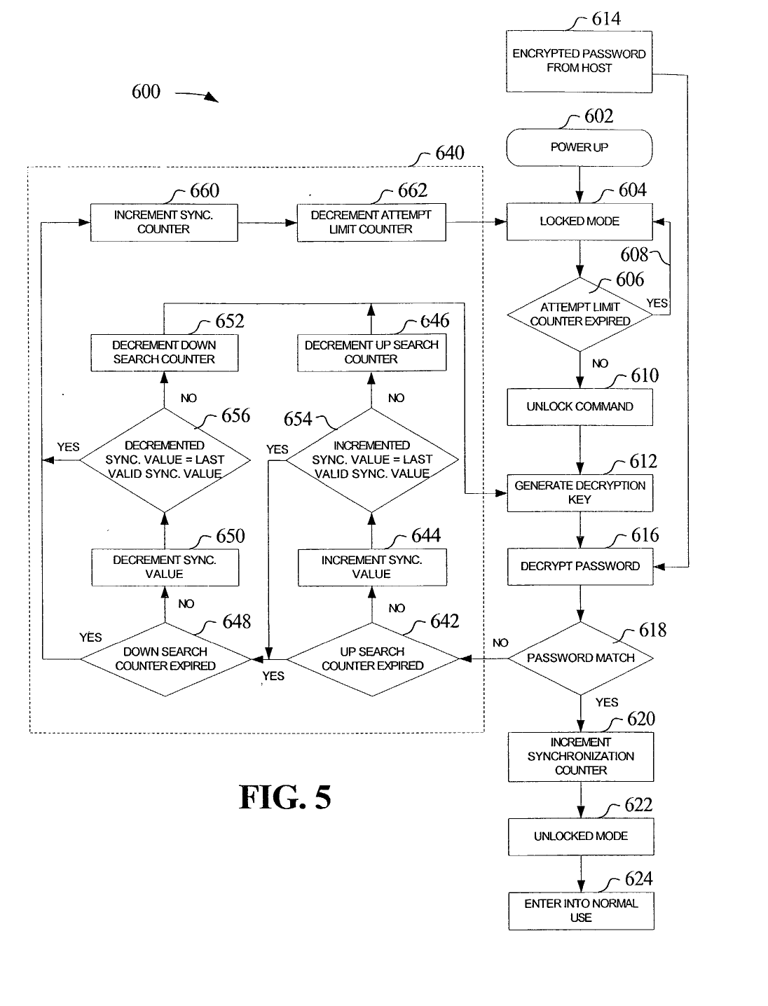

The operation of a data storage device 320, such as a disc drive 100, will be discussed in a general sense before discussing further details of the operation with respect to FIG. 5. The data storage device 320 receives the encrypted password. The device 320 then generates the decryption key based on the synchronization counter 324. Then, the encrypted password is decrypted using the decryption key. The password is then checked to see if it matches the stored password. If the password matches, the data storage device 320 is unlocked, otherwise the data storage device 320 is still in locked mode. After an unlock attempt, the synchronization counter 324 is incremented and the result of the unlock attempt is reported to the host computer 2000. The encryption and decryption keys change with every update of the synchronization counters 314 and 324. Thus, the encrypted password is varying at each transmission even if the original password is unchanged.

According to another embodiment of the present invention, if the passwords do not match, the synchronization counter is incremented or decremented within a selected number. If a match is found after incrementing or decrementing the synchronization counter value, the data storage device reports the result of the unlock attempt to the host computer.

FIG. 5 is a flowchart showing the procedure 600 associated with the data storage device 320 during the operation of the CE product 300 according to one embodiment of the present invention. As shown in FIG. 5, the data storage device 320 is powered up, as depicted by reference numeral 602. The data storage device 320 is in a locked mode when powered up, as depicted by reference numeral 604. The data storage device 320 may be provided with a limit counter that limits the number of attempts for accessing the data storage device 320. This may limit the total number of attempts to switch from a locked mode to an unlocked mode or it may limit just the unsuccessful attempts to switch from a locked mode to an unlocked mode. Then next step in the process is to determine if the attempt limit counter has reached the allowed limit as depicted by the decision block shown by reference number 606. If the limit counter has reached the maximum allowable number of attempts, the data storage device 320 remains in the locked mode, as depicted by the yes arrow 608. If the attempt limit counter has not reached the maximum allowable number of attempts, the data storage device receives an unlock command, as depicted by reference numeral 610. The data storage device 320 then generates a decryption key, as depicted by reference numeral 612.

An encrypted password from the host computer 2000 is received by the data storage device 320 as depicted by reference numeral 614. The encrypted password from the host computer is then decrypted using the decryption key generated in step 616.

Note that the decryption key used is associated or linked to the synchronization counter 324 of the data storage device 320. In other words, the decryption key changes with the update of synchronization counter 324.

Similarly, the encryption key used to encrypt the password is generated from the value of the synchronization counter 314 of the host computer 2000. In other words, the encryption key changes with the update of synchronization counter 314. Therefore, if the counters 314 and 324 are updated after every transmission, the encrypted password varies with each transmission even if the original password remains unchanged.

Next, the decrypted password is compared to the password stored in the data storage device 320. A determination is then made whether or not the decrypted password matches the password from the data storage device 320 as depicted by reference numeral 618. If the decrypted password from the host computer 2000 matches the password stored in the data storage device 320, then the synchronization counter 324 of the data storage device 320 is incremented, as shown by reference numeral 620. The increment may be the valid synchronization counter value, plus one. However, the amount of the increment could be changed to other than one. After updating the synchronization counter 324, the data storage device enters an unlocked mode, as depicted by reference numeral 622. The disk drive then can enter into normal use, as depicted by reference numeral 624.

Step 3: Unlock a Matched Drive After Mismatch

When the decrypted password does not match the stored password, a resynchronization procedure 640 may be attempted. The data storage device and its designated host may lose synchronization for many reasons. That is the data storage device 320 may have a different value of synchronization counter from its designated host. Thus, the recovery of synchronization, i.e. resynchronization, may be required when the data storage device 320 is reconnected to the designated CE product 300 and when the system is powered up.

One method of obtaining resynchronization between the drive and its designated host is to allow the drive to search valid synchronization values within a given range whenever the data storage device 320 does not obtain a valid password, after reference numeral 618. To accomplish resynchronization, two search counters, an increment search counter and a decrement search counter, may be implemented.

If the decrypted password from the host computer 2000 does not match the stored password on the data storage device 320, the resynchronization procedure begins. The first step in the resynchronization procedure is to count the number of decryption attempts that were made by incrementing the synchronization counter value to obtain a new decryption key. The number of attempts made by incrementing may have a predefined maximum. If the maximum number of increment searches has not expired, as depicted by decision box 642, the synchronization value is incremented, as depicted by reference numeral 644. A determination is then made whether or not the incremented synchronization value is equal to the last valid synchronization value, as depicted by reference number 654. This step is to avoid using any previously used synchronization value. If the incremented synchronization value doesn't equal the last valid synchronization value, the incremented synchronization value is then used to generate the decryption key, as depicted by reference numeral 612. Then, the increment search counter is decremented, as depicted by reference numeral 646.

The incremented synchronization value is then used to decrypt the password received from the host computer, and then the newly formed decrypted password is compared to the stored password to determine if there is a match. If there is a match, the synchronization counter 324 is updated and incremented, and the drive enters the unlocked mode where normal use begins. If the decrypted password does not match the stored password, then another cycle of incrementing the synchronization value takes place. This cycle is then repeated until the increment search counter has reached the maximum allowed or the last valid synchronization value is reached.

If the increment search counter has expired or the last valid synchronization value is reached, then decrementing from the synchronization value begins. The first step is to count the number of decryption attempts that were made by decrementing the synchronization counter value to obtain a new decryption key. The number of attempts made by decrementing may have a predefined maximum. If the maximum number of decrement searches has not expired, as depicted by decision box 648, the synchronization value is decremented, as depicted by reference numeral 650.

A determination is then made whether or not the decremented synchronization value is equal to the last valid synchronization value, as depicted by reference number 656. This step is to avoid using any previously used synchronization value. If the decremented synchronization value does not equal the last valid synchronization value, the decremented synchronization value is then used to generate the decryption key, as depicted by reference numeral 612. Then, the decrement search counter is decremented, as depicted by reference numeral 652. The decremented synchronization value is then used to decrypt the password received from the host computer, and then the newly formed decrypted password is compared to the stored password to determine if there is a match. If there is a match, the synchronization counter 324 is updated and incremented, and the drive enters the unlocked mode where normal use begins. If the decrypted password does not match the stored password, then another cycle of decrementing the synchronization value takes place. This cycle is then repeated until the decrement search counter has reached the maximum allowed or the last valid synchronization value is reached.

Preferably, the decrement and increment search counters are set with a predefined number of maximum allowable attempts. When the counters reach zero, the system knows that the maximum allowable attempts have been reached.

In other words, the search counters count the number of valid synchronization values being searched by incrementing or decrementing the current value of synchronization counter. Once the data storage device 320 gets the valid password with a certain valid synchronization value, the synchronization counter of the data storage device shall be updated with that valid synchronization value plus one. Thus, the data storage device and its designated host computer 2000 obtain resynchronization. However, if the absolute difference of synchronization counters 324 and 314 in the data storage device 320 and the host computer 2000 is beyond the valid range of synchronization values, the data storage device 320 may be locked forever. To reuse the data storage device 320, only a master password can be used to unlock it. Preferably, all data stored on the data storage device 320 is erased when the master password is required.

Step 4: Unlock a Mismatched Drive

Suppose that a mismatched data storage device 320 sometime replaces the matched data storage device 320 in the CE product 300. This may occur when the matched data storage device 320 is moved to another system or when a data storage device that is not matched to the current host is inserted into the system. For the CE product 300, the same procedure is followed to unlock the data storage device 320. The data storage device 320 remains in the locked state since it cannot get a valid password to unlock. An incorrect original password (which is encrypted in the host) or mismatched encryption key and decryption key may contribute to an unsuccessful unlock. An attempt limit counter, depicted as reference number 606, will defeat repeated trial attacks or repeated attempts to unlock the data storage device 320. When the maximum number of attempts has been reached by the attempt limit counter 606, the unlock command is aborted until some predefined reset criteria has occurred. Preferably, the predefined reset criteria is a power-on or hardware reset.

In summary, the present invention can obtain a unique encrypted password at each transmission to a data storage device 320 over bus 330 by updating synchronization counters 314 and 324. The present invention provides for only the encrypted password being sent to a data storage device 320 over a bus 330. Preferably, a 128-bit synchronization counter can sufficiently defeat any attempt to crack the password by an exhaustive search. The above described methods and apparatuses thus ensures the security of a CE product 300 even if the encryption and decryption algorithms are known. Moreover, preferred embodiment of the present invention not only fixes the match problem between a host 2000 and a data storage device 320 in a simple way, but also implements resynchronization between the CE product 300 and its designated data storage device 320 when loss of synchronization happens.

Advantageously, the apparatuses and methods used provide a way to match a data storage device, such as a hard disc drive, to a designated host. Further, it is difficult or even impossible to use the data storage device 320 in any other system other than its designated host 2000. The ability to lock a data storage device 320 to a designated host 2000 is especially significant and beneficial for CE products. Thus, this feature is highly important to prevent unauthorized copying of data (music, video, etc.) that is stored on a device similar to data storage device 320.

In addition, the security features of the preferred embodiment of the present invention protect the data storage device 320 from attacks. Moreover, the starting synchronization counter value may be randomly assigned at the time of manufacture to both the host computer 2000 and the data storage device 320 in order to lessen the possibility that a designer of the security features could publicly disclose a method or apparatus to break the encryption or decryption keys. Therefore, the security features of the preferred embodiment of the present invention have significantly more secure features than past security techniques.

### Conclusion

A security method for providing security between a host device 2000 and at least one data storage device 320, includes generating an encryption key 512 from a first counter 314, encrypting a password 514 according to the encryption key 512 to obtain an encrypted password, transmitting 516 the encrypted password 614 from the host 2000 to the data storage device 320, generating a decryption key 612 from a second counter 324 that is synchronized with the first counter 314, and decrypting 616 the encrypted password according to the decryption key to obtain the password.

Optionally, the method can also include a step of incrementing 518 and 620 the first and second counters, 314 and 324, after a predetermined criteria has been met, effectively creating a different encrypted password than the previous encrypted password. Further, the predetermined criteria may be when a successful access to the data storage device is completed or after a specified period of time. The predetermined criteria may be each transmission between the host and the data storage device. Also, the predetermined criteria may be a function of the host 2000 or the data storage device 320.

Another contemplated embodiment is a security system including a host device 2000, a data storage device 320 operatively coupled 330 to the host device 2000, and a password, which is sent from the host device 2000 to the data storage device 320, where the password changes with a transmission from the host 2000 to the data storage device 320.

Optionally, the security system may include a first counter 314 in communication with the host device 2000, a second counter 324 in communication with the data storage device 320, the second counter 324 synchronized to the first counter 314, an encryption key 512 generated by the first synchronization counter 314, an encrypted password generated 514 by the encryption key and the password prior to being sent from the host device 2000.

The security system may also include a data transmission system that transmits the encrypted password to the data storage device 320, a data transmission system that receives the encrypted password from the host 2000, a decryption key generated by the second counter 324, corresponding to the encryption key that was generated by the first counter 314, the password being regenerated by the decryption key after being received by the data storage device 320.

Further, the encrypted password may be altered due to the occurrence of a change in the encryption key. The change in the encryption key may be due to an increment of the first counter 314. Preferably, an end user can not access the first counter 314 and second counter 324.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the security system and method while maintaining substantially the same functionality without departing from the scope and spirit of the present invention. In addition, although the preferred embodiment described herein is directed to a disc drive for a data storage system, it will be appreciated by those skilled in the art that the teachings of the present invention can be applied to other systems, like consumer electronic systems that are capable of storing data, such as MP3 players and digital video playback equipment, without departing from the scope and spirit of the present invention.

What is claimed is:

1. A security method for providing security between a host device and at least one data storage device, comprising the steps of:
generating an encryption key from a first counter;
encrypting a password according to the encryption key to obtain an encrypted password;
transmitting the encrypted password from the host to the data storage device;
generating a decryption key from a second counter, operatively coupled to the data storage device, that is synchronized with the first counter; and
decrypting the encrypted password according to the decryption key to obtain the password.

2. The method of claim 1 further comprising a step of incrementing the first and second counters after a predetermined criteria has been met, effectively creating a different encrypted password than the previous encrypted password.

3. The method of claim 2 where the predetermined criteria is every successful access to the data storage device.

4. The method of claim 2 where the predetermined criteria is a specified period of time.

5. The method of claim 2 where the predetermined criteria is each transmission between the host and the data storage device.

6. The method of claim 2 where the predetermined criteria is a function of the host.

7. The method of claim 2 where the predetermined criteria is a function of the data storage device.

8. The method of claim 1 further comprising the step of:
resynchronizing the password when the decrypted password does not match a stored password.

9. The method of claim 8 wherein the resynchronizing step further comprises:
allowing the data storage device to search valid synchronization values within a given range whenever the data storage device does not obtain a valid password.

10. The method of claim 9 wherein the resynchronizing step further comprises
updating the second counter with a valid synchronization value plus one, after the data storage device receives the valid password with a certain valid synchronization value.

11. A security system comprising:
a host device;
a data storage device operatively coupled to the host device; and
a password, which is sent from the host device to the data storage device, where the password changes with a transmission from the host to the data storage device.

12. The security system of claim 11, further comprising:
a first counter in communication with the host device;
a second counter in communication with the data storage device, the second counter synchronized to the first counter;
an encryption key generated by the first synchronization counter;
an encrypted password generated by the encryption key and the password prior to being sent from the host device.

13. The security system of claim 12 further comprising:
a data transmission system that transmits the encrypted password to the data storage device;
a data transmission system that receives the encrypted password from the host;
a decryption key generated by the second counter, corresponding to the encryption key that was generated by the first counter;
the password, regenerated by the decryption key, after being received by the data storage device.

14. The security system of claim 12, where the encrypted password is altered due to the occurrence of a change in the encryption key.

15. The security system of claim 14 where the change in the encryption key is due to an increment of the first counter.

16. The security system of claim 12 where an end user can not access the first counter and second counter.

17. The security system of claim 12 wherein a combination of the first synchronization counter value and the password is encrypted before sending to the data storage device.

18. The security system of claim 11 wherein the data storage device is a disc drive.

19. The security system of claim 12 wherein the data storage device stores the password and the value of the synchronization counter on an area unavailable to a user.

20. A security system including:
a host;
a data storage device; and
means for transmitting and receiving encrypted passwords.

21. The security system of claim 20 wherein the means for transmitting and receiving encrypted passwords includes a means for encrypting and decrypting a password.

22. The security system of claim 20 further including at least one counter.

23. The security system of claim 20 wherein passwords are stored in an area unavailable to a user.

24. The security system of claim 22 wherein the value of a counter is used to encrypt the password.

25. The security system of claim 22 wherein the value of a counter is used to decrypt the password.
